(19) United States
(12) Patent Application Publication
(10) Pub. No.: US 2014/0073352 A1
(43) Pub. Date: Mar. 13, 2014

(54) METHOD FOR PRECISE LOCATION DETERMINATION

(71) Applicant: QUALCOMM Incorporated, San Diego, CA (US)

(72) Inventors: Carlos Horacio ALDANA, Mountain View, CA (US); Ning ZHANG, Saratoga, CA (US)

(73) Assignee: QUALCOMM Incorporated, San Diego, CA (US)

(21) Appl. No.: 14/023,098

(22) Filed: Sep. 10, 2013

Related U.S. Application Data
(60) Provisional application No. 61/699,739, filed on Sep. 11, 2012.
(60) Provisional application No. 61/716,465, filed on Oct. 19, 2012.
(60) Provisional application No. 61/721,437, filed on Nov. 1, 2012.

(51) Int. Cl. G01S 5/10

(52) U.S. Cl. CPC G01S 5/10
USPC 455/456.1

(57) ABSTRACT

According to embodiments, methods are presented to for determining precise location of a device by exchanging a plurality of messages with one or more devices (e.g., access points or mobile devices) in vicinity. Embodiments may calculate distance between the devices using round trip time that takes to transmit and receive signals to/from each of the devices. Using definitions that account for multiple input multiple output (MIMO) transmission, the embodiments determine precise location of a device.

### CROSS-REFERENCE TO RELATED APPLICATIONS

The present application for patent claims priority to Provisional Application No. 61/699,739 entitled “Methods for Precise Locationing and Wireless Transmissions in 802.11 Standards” filed Sep. 11, 2012, and Provisional Application No. 61/716,465 entitled “Methods for Precise Location Determination and Wireless Transmissions in 802.11 Standards” filed Oct. 19, 2012, and Provisional Application No. 61/721,437 entitled “Methods for Precise Location Determinations and Wireless Transmissions in 802.11 Standards” filed Nov. 1, 2012, all of which assigned to the assignee hereof and hereby expressly incorporated by reference herein.

### TECHNICAL FIELD

The present application relates generally to wireless communications, and more particularly to precise location determination in wireless communication systems.

### BACKGROUND

Devices utilizing protocols specified in current versions of 802.11 standards may lack, for example, details sufficient to handle transmissions from multiple antennas and/or efficient message exchanges suitable for determining distance between two or more devices. It is desirable to operate wireless devices conforming to more precise messaging protocols. Moreover, by being precise in how multiple radio frequency chains are treated, algorithms performed to acquire exact timing and/or determine precise location of a device can be designed.

### SUMMARY

Certain embodiments present a method for determining a distance between a first device and a second device. The method generally includes, in part, at the first device, receiving a first signal front the second device. The method may include in response to receiving the first signal, transmitting a second signal front the first device using a first antenna. The first device may include a plurality of antennas including the first antenna, and the first device may use only a first antenna and no other antenna in the plurality of antennas to transmit the second signal. Moreover, the method may include, in part, receiving one or more first timing measurements corresponding to the first and the second signals from the second device, and determining the distance between the first device and the second device based at least on the one or more first timing measurements.

In an embodiment, the method includes transmitting a timing measurement request to the second device, wherein the first signal is received in response to the timing measurement request. In another embodiment, the method includes determining one or more second timing measurements, comprising time of arrival of the first signal at the first device and time of departure of the second signal from the first device, and determining round trip time (RTT) based on the one or more first timing measurements and the one or more second timing measurements. The distance may be determined based at least on the round trip time, in one embodiment, the RTT is determined based at least on the following equation: RTT=(t4−t1)−(t3−t2), wherein t1 represents time of departure of the first signal from the second device, t2 represents the time of arrival of the first signal at the first device, t3 represents the time of departure of the second signal from the first device and t4 represents time of arrival of the second signal at the first device.

In an embodiment, the method may include determining time of flight (TOF) of the first signal based at least on time of departure of the first signal from the second device and the time of arrival of the first signal at the first device, and determining the distance based at least on the TOF.

In an embodiment, time of arrival of the first signal may include the earliest time that the first signal is received by one or more antennas of the first device. Alternatively, the time of arrival of the first signal may include arrival time of the first signal at one of the receive antennas of the first device with highest received signal strength among all of the receive antennas of the first device. In yet another embodiment, the time of arrival of the first signal may include a weighted sum of one or more arrival times of the first signal at one or more receive antennas of the first device.

In an embodiment, receiving the first signal includes, in part, receiving the first signal with a sampling rate less than 10 nanoseconds (ns) (e.g., 0.1 ns). In another embodiment, the communications comply with one of the Institute of Electrical and Electronics Engineers (IEEE) 802.11v, 802.11ad, 802.11mc or 802.11ac standards.

For certain embodiments, the one or more timing measurements include a difference measurement between a first time stamp indicative of time of arrival of the first signal at the first device and a second time stamp indicative of time of departure of the second signal from the first device. Therefore, determining distance from the second may include determining RTT based at least on the difference measurement, and determining distance front the second device based at least on the determined RTT. The difference measurement and the RTT may be determined based on the following equations: Δ=t4−t1, and RTT=Δ−(t3−t2), wherein Δ represents the difference measurement.

In an embodiment, the method further includes, transmitting a timing measurement request to a plurality of second devices, and determining at least three distance measurements corresponding to least three of the plurality of second devices. The method may further include determining position of the first device based on the at least three distance measurements and global positioning information of each device corresponding to each of the distance measurements. In another embodiment, the method may further include transmitting the one or more second timing measurements to the second device.

Certain embodiments present a method for a distance between a first device and a second device. The method may generally include, in part, transmitting by the second device, a first signal to the first device using a first antenna. The second device may include a plurality of antennas including the first antenna, and the second device uses only the first antenna and no other antenna in the plurality of antennas to transmit the first signal. The method may further include receiving a second signal from the first device in response to reception of the first signal, determining one or more first timing measurements corresponding to the first and the second signals, and transmitting the one or more first timing measurements to the first device.

In an embodiment, the method may further include receiving a timing measurement request and transmitting the first signal in response to the timing measurement request. In one embodiment, determining the one or more timing measurements includes capturing time of departure of the first signal from the second device and time of arrival of the second signal at the second device.

In an embodiment, the time of arrival of the second signal may include the earliest lime that the second signal is received by one or more antennas of the second device. In another embodiment, the time of arrival of the second signal may include arrival time of the second signal at one of the receive antennas of the second device with highest received signal strength among all of the receive antennas of the second device. In yet another embodiment, the time of arrival of the second signal may include a weighted SLIM of one or more arrival times of the second signal at one or more receive antennas of the second device.

In an embodiment, the method further includes receiving one or more second timing measurements from the first device, determining RTT based at least on the one or more first timing measurements and the one or more second timing measurements, and determining the distance from the first device based at least on the RTT. For example, the RTT may be determined based at least on the following equation: RTT=(t4−t1)−(t3−t2), wherein t1 may represent the time of departure of the first signal from the second device, t2 may represent time of arrival of the first signal at the first device, t3 may represent time of departure of the second signal from the first device and, t4 may represent the time of arrival of the second signal at the second device.

In an embodiment, receiving the second signal includes receiving the second signal with a sampling rate less than 10 ns. In another embodiment, receiving the second signal includes receiving the second signal with a sampling rate equal to 0.1 ns.

In an embodiment, the method further includes receiving one or more second timing measurements the first device, and determining distance from the first device based at least on the one or more second timing measurements. In addition, the one or more second timing measurements may include a difference measurement between a first time stamp indicative of time of arrival of the first signal at the second device and a second time stamp indicative of time of departure of the second signal from the second device. In an embodiment, the method includes determining RTT based at least on the difference measurement and determining the distance from the first device based at least on the determined RTT.

Certain embodiments of the present disclosure present an apparatus for determining a distance from a device. The apparatus generally includes, in part, a plurality of antennas, a receiver configured to receive a first signal from the device using at least one of the plurality of antennas, a transmitter configured to transmit, in response to receiving the first signal, a second signal using a first antenna of the plurality of antennas, wherein the apparatus uses only the first antenna and no other antenna in the plurality of antennas to transmit the second signal. The receiver may further be configured to receive one or more first timing measurements corresponding to the first and the second signals. The apparatus may further include a processor configured to determine the distance from the device based at least on the one or more first timing measurements and a memory coupled to the processor.

Certain embodiments of the present disclosure present an apparatus for determining a distance from a device. The apparatus generally includes, in part, a plurality of antennas, a transmitter configured to transmit a first signal to the device using a first antenna of the plurality of antennas, wherein the apparatus uses only the first antenna and no other antenna in the plurality of antennas to transmit the first signal, a receiver configured to receive a second signal from the first device in response to reception of the first signal, and a processor configured to determine one or more first timing measurements corresponding to the first and the second signals, wherein the transmitter is further configured to transmit the one or more first timing measurements to the device.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is an example multiple access wireless communication system according to some embodiments.

FIG. 2 is an example wireless communications interface including a transmitter system and a receiver system according to some embodiments.

FIG. 3 is an example wireless communications environment of a user equipment (WE) according to some embodiments.

FIG. 4 illustrates example operations that may be performed for precise location determination by an initiating device, in accordance with certain embodiments of the present disclosure.

FIG. 5 illustrates example operations that may be performed for precise location determination by a helping device, in accordance with certain embodiments of the present disclosure.

FIGS. 6A through 6E are example charts describing message exchanges between two devices for precise location determination, in accordance with certain embodiments of the present disclosure.

FIG. 7 illustrates an example message format for a fine timing measurement frame, in accordance with certain aspects of the present disclosure.

FIG. 8 illustrates an example message format for a fine timing measurement request frame, in accordance with certain aspects of the present disclosure.

FIG. 9 illustrates an example message format for a fine timing measurement negotiation frame, in accordance with certain aspects of the present disclosure.

FIG. 10 is an example computer system that can be used for precise location determination, in accordance with certain embodiments of the present disclosure.

### DETAILED DESCRIPTION

As used herein, an “access point” (AP) may refer to any device capable of and/or configured to route, connect, share, and/or otherwise provide a network connection to one or more other devices. An access point may include one or more wired and/or wireless interfaces, such as one or more Ethernet interfaces anchor one or more IEEE 802.11 interfaces, respectively, via which such a connection may be provided. For example, an access point, such as a wireless router, may include one or more Ethernet ports to connect to a local modem or other network components (e.g., switches, gateways, etc.) and/or to connect to one or more other devices to which network access is to be provided, as well as one or more antennas and/or wireless networking cards to broadcast, transmit, and/or otherwise provide one or more wireless signals to facilitate connectivity with one or more other devices.

Various embodiments are described herein in connection with a user equipment (UE). A UE can also be called an access terminal, a system, subscriber unit, subscriber station, mobile station, station, mobile, remote station, remote terminal, mobile device, user terminal, terminal, wireless communication device, user agent or user device. A UE can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem.

Embodiments described herein may enable acquiring position of a mobile device using wireless access points (APs) and/or other mobile devices. Rather than relying on satellite signals or assistance data from terrestrial base stations transmitting satellite geo-positioning data, mobile devices may acquire their geographic locations using wireless APs. Alternatively, a mobile device may determine its position using peer to peer communication with other mobile devices, as described herein. The APs and the mobile devices may transmit and receive wireless signals following various IEEE 802.11 standards, such as 802.11g/n/v/ac/ad/mc, and the like.

It should be noted that acquiring a position of a mobile device to achieve a similar effect to conventional GPS devices may require extensive communications between wireless devices. IEEE 802.11 standards may not be robust enough to account for the intensive traffic needed to constantly update a mobile device's position. Moreover, some wireless devices may utilize multiple antennas in a multiple-input multiple-output (MIMO) configuration to improve throughput and/or strengthen signal reliability. Current implementations in the art of various existing wireless devices have multiple chains enabled when transmitting and receiving packets. However, it may be difficult discriminate among the transmit chains when looking at the impulse response in the time domain. Certain embodiments force a single chain in the transmitter to eliminate the ambiguity in RE chains and enable determining exact location of a device.

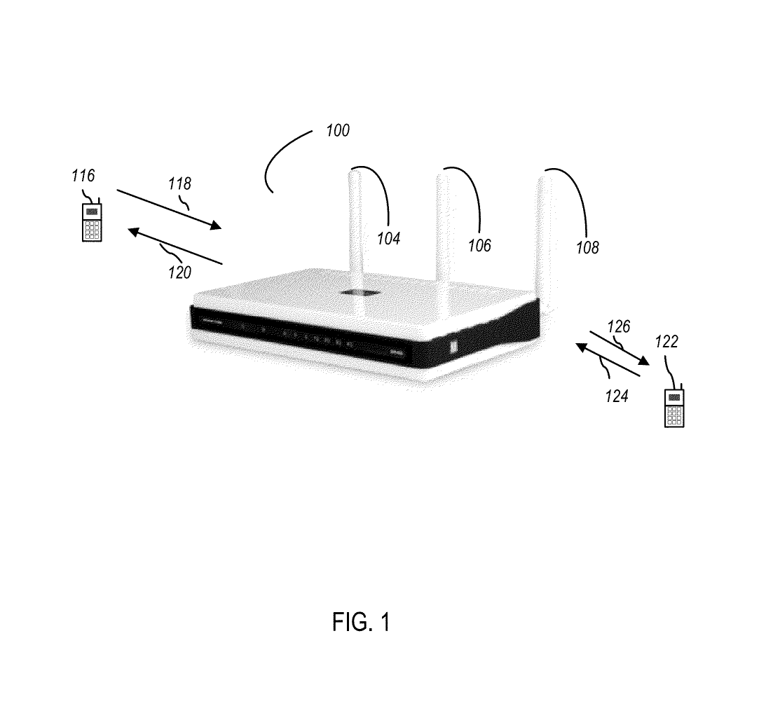

Referring to FIG. 1, an example multiple-access AP utilized in some embodiments is presented. AP 100 includes multiple antennas, including 104, 106, and 108. More or fewer antennas may be utilized in other embodiments. UE 116 may be in communication with AP 100 via antenna 104, where antenna 104 may transmit signals to UE 116 over forward link 120 and may receive signals from UE 116 over reverse link 118. UE 122 is in communication with AP 100 via antenna 108, where antenna 108 may transmit signals to UE 122 over forward link 126 and may receive signals from UE 122 over reverse link 124. In a Frequency Division Duplex (FDD) system, communication links 118, 120, 124 and 126 may use different frequencies for communication. For example, forward link 120 may use a different frequency than that used by reverse link 118. In some embodiments, antennas 104, 106, and 108 may each be in communication with both UEs 116 and 122. UE 116 may be in communication with AP 100 in a first frequency, while LIE 122 may be in communication with AP 100 in a second frequency, for example. In some embodiments, multiple antennas, e.g. antennas 104 and 106, may be in communication with just a single mobile device, e.g. UE 116. Multiple antennas may be used to transmit the same type of data but arranged in different sequences to improve diversity gain.

Each group of antennas and/or the area in which they are designed to communicate is often referred to as a sector of the AP. In some embodiments, antenna groups each are designed to communicate to UEs in a sector of the areas covered by AP 100.

In communication over forward links 120 and 126, the transmitting antennas of AP 100 may utilize beamforming in order to improve the signal-to-noise ratio of forward links for the different UEs 116 and 122. Also, an AP using beamforming to transmit to UEs scattered randomly through its coverage causes less interference to UEs in neighboring cells than an AP transmitting through a single antenna to all its UEs.

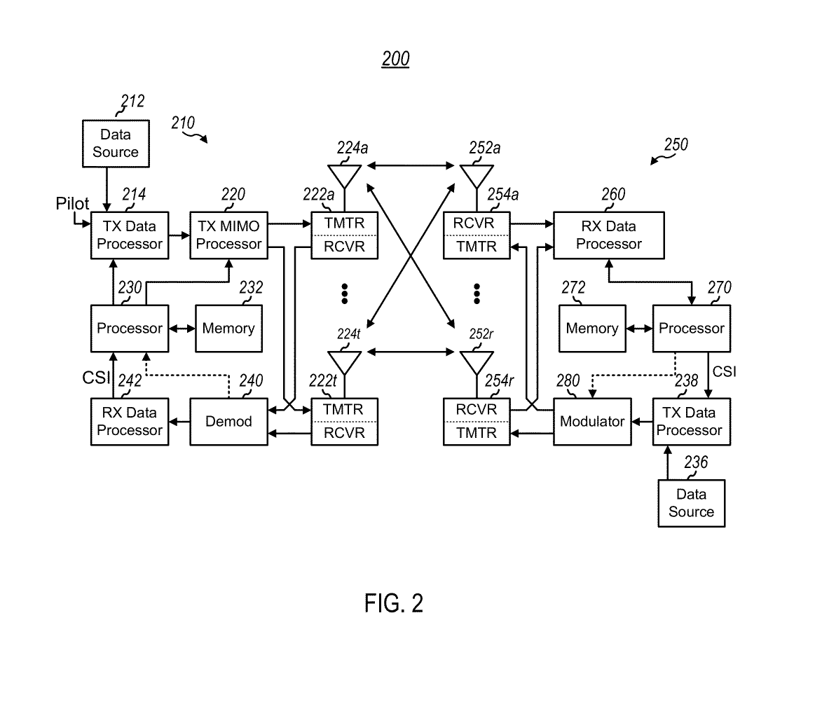

FIG. 2 is a block diagram of an embodiment of a transmitter system 210 of an AP and a receiver system 250 of a UE in a multiple-input and multiple-output (MIMO) system 200 according to some embodiments. Alternatively, the transmitter system 210 may correspond to a UE and the receiver system 250 may correspond to an AP.

At the transmitter system 210, traffic data for a number of data streams is provided from a data source 212 to a transmit (TX) data processor 214. In some embodiments, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using orthogonal frequency division multiplexing (OMNI) techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., binary phase shift keying (BPSK), Quadrature phase shift keying (QPSK), M-PSK, or M-QAM (Quadrature amplitude modulation) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides NT modulation symbol streams to NT transmitters (TMTR) 222a through 222t, where NT is a positive integer associated with transmitters described in FIG. 2. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 222a through 222t are then transmitted from NT antennas 224a through 224t, respectively.

At receiver system 250, the transmitted modulated signals are received by NR antennas 252a through 252r and the received signal from each antenna 252 is provided to a respective receiver (RCYR) 254a through 254r, where NR is a positive integer associated with receivers described in FIG. 2. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide NT “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use. Processor 270 formulates a reverse link message comprising a matrix index portion and a rank value portion. Memory 272 stores the various pre-coding, matrices that are used by processor 270.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message. Memory 232 may contain the pre-coding matrices and other types of data, such as information databases and locally and globally unique attributes of multiple base stations.

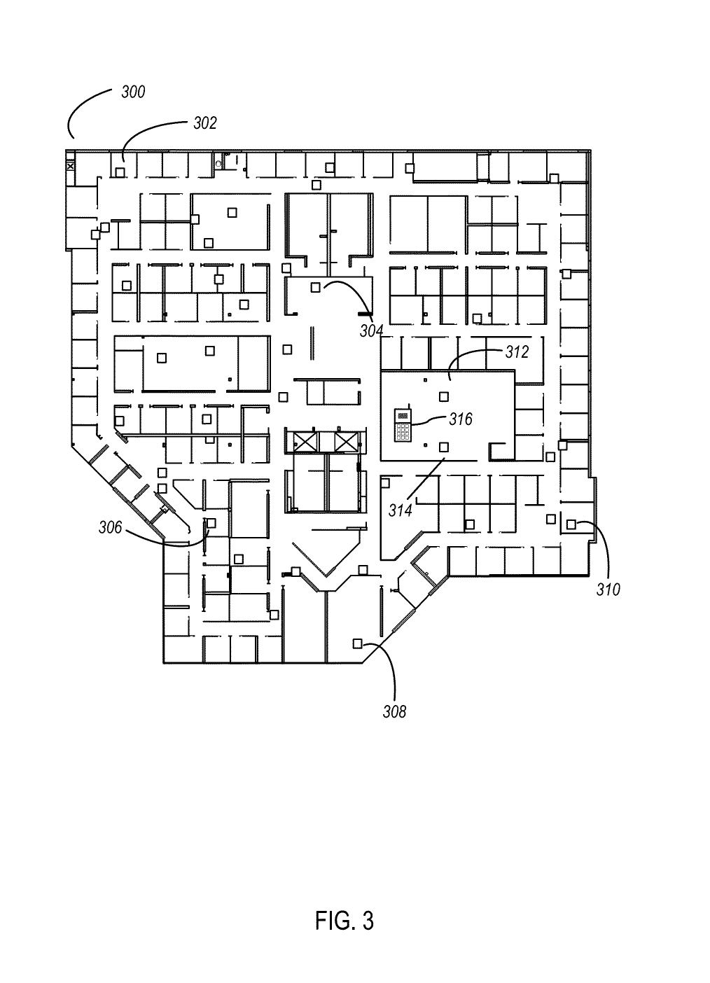

Referring to FIG. 3, embodiments may include a UE 316 operating within a wireless network environment 300 of APs. The UE 316 may refer to any apparatus used and/or operated by a user or consumer, such as a mobile device, cell phone, electronic tablet, touch screen device, radio, GPS device, etc. The UE 316 may attempt to determine its global position or access global positioning information for other purposes, utilizing the APs in the wireless environment, such as APs 302, 304, 306, 308, 310, 312, and 314 as examples. In another embodiment, the UE 316 may use help from other UEs in its vicinity to determine its position. The APs and/or the UEs may be configured to transmit and receive messages to and from multiple UEs, and may be consistent with those described in FIGS. 1 and 2.

In some embodiments, APs and UEs may transmit and receive signals and/or timing measurements to each other. A UE may obtain timing measurements from three or more devices (e.g., APs or other UEs) and geographical positioning information from the APs. The UE may then be able to determine its location by performing techniques similar to global positioning system (GPS) positioning (e.g., trilateration and the like) using the timing measurements.

Still referring to FIG. 3, APs used in performing geo-positioning with UE 316 may follow 802.11 standards for wireless local area network (WLAN) communications, but the standards may not be sufficient to assist in geo-positioning when the APs employ MEMO messaging techniques. This may be because the current 802.11 standards governing MIMO messaging (e.g., 802.11ac, 802.11v, and 802.11-2012) lack precise enough definitions that are required when performing real-time geo-positioning at rates as quick as conventional GPS techniques.

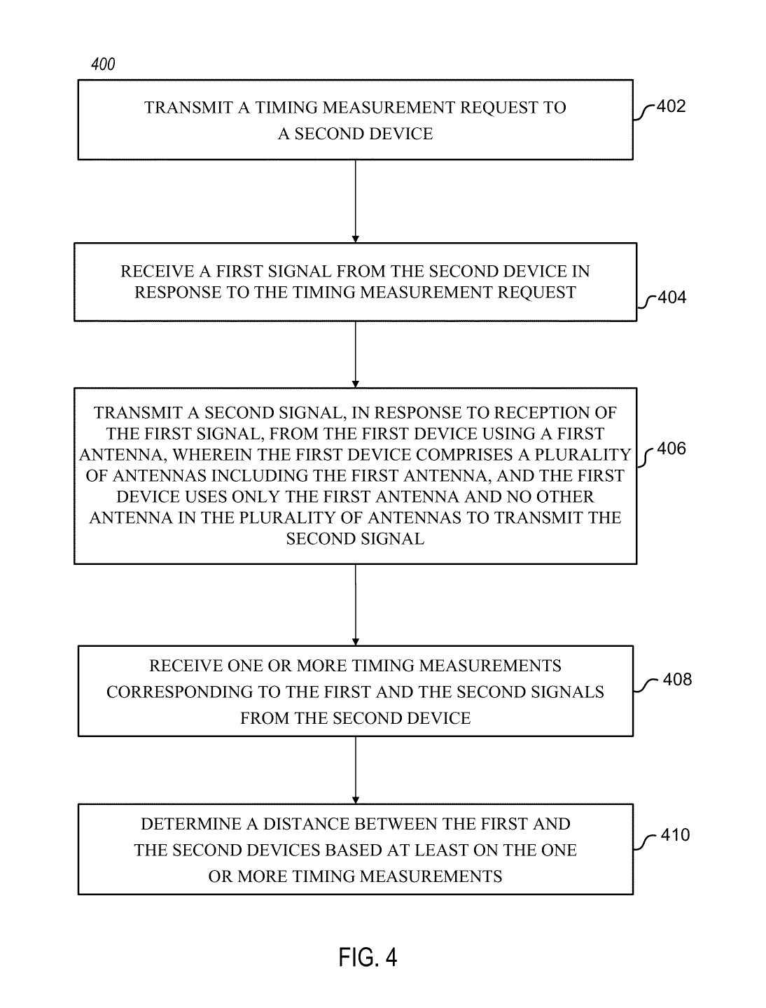

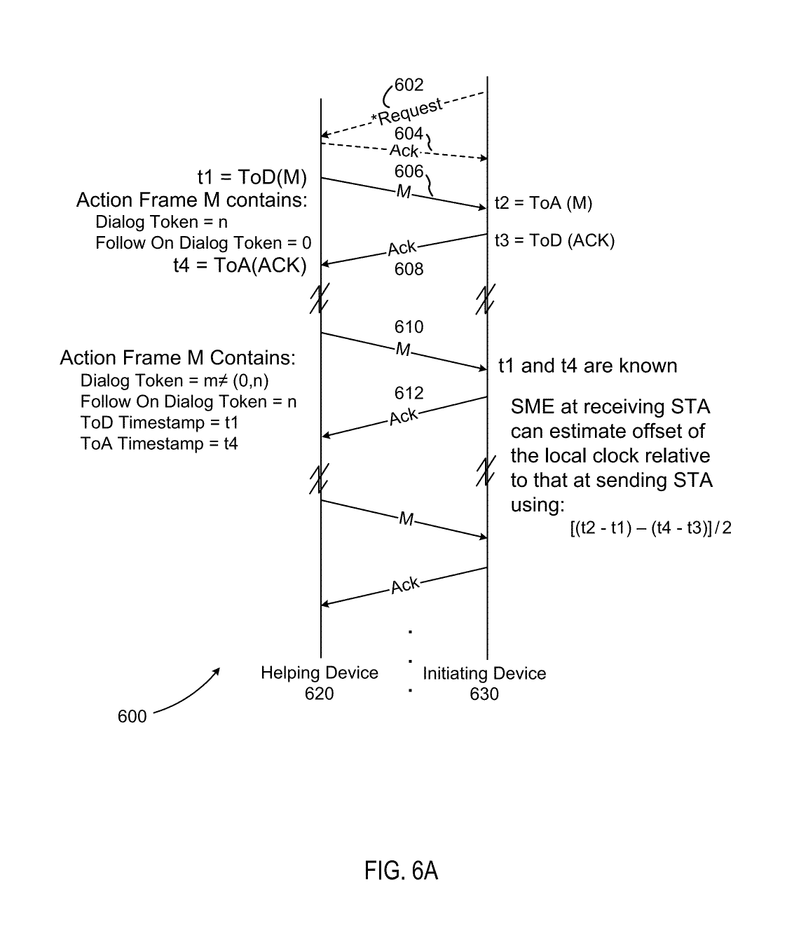

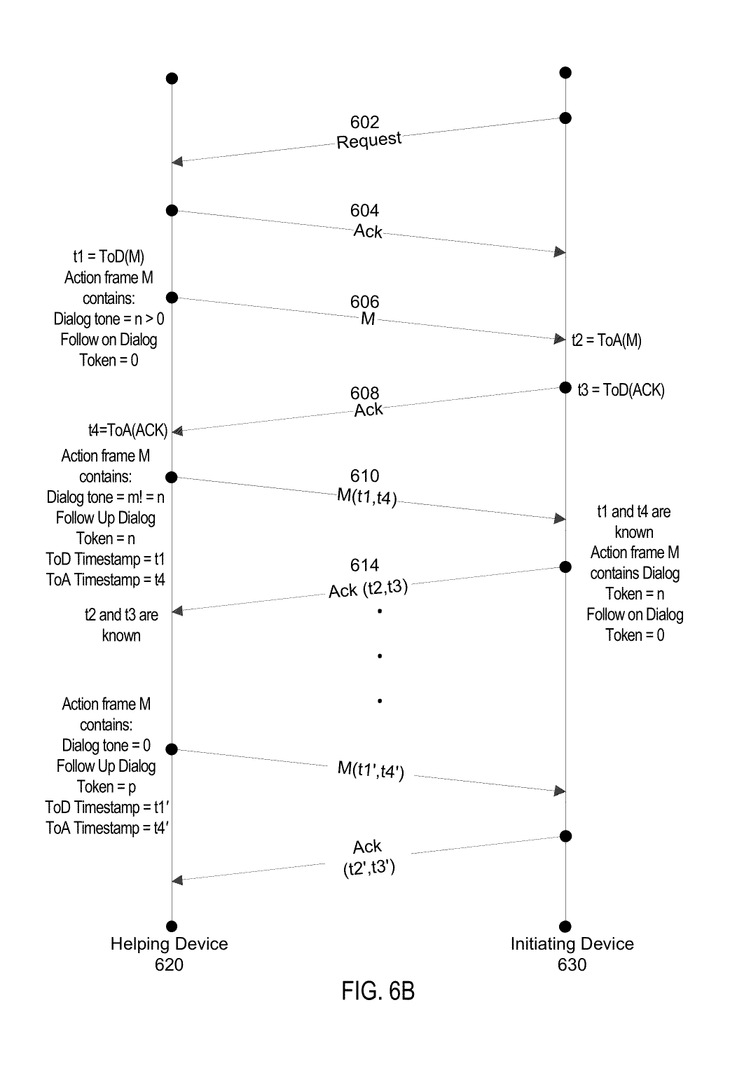

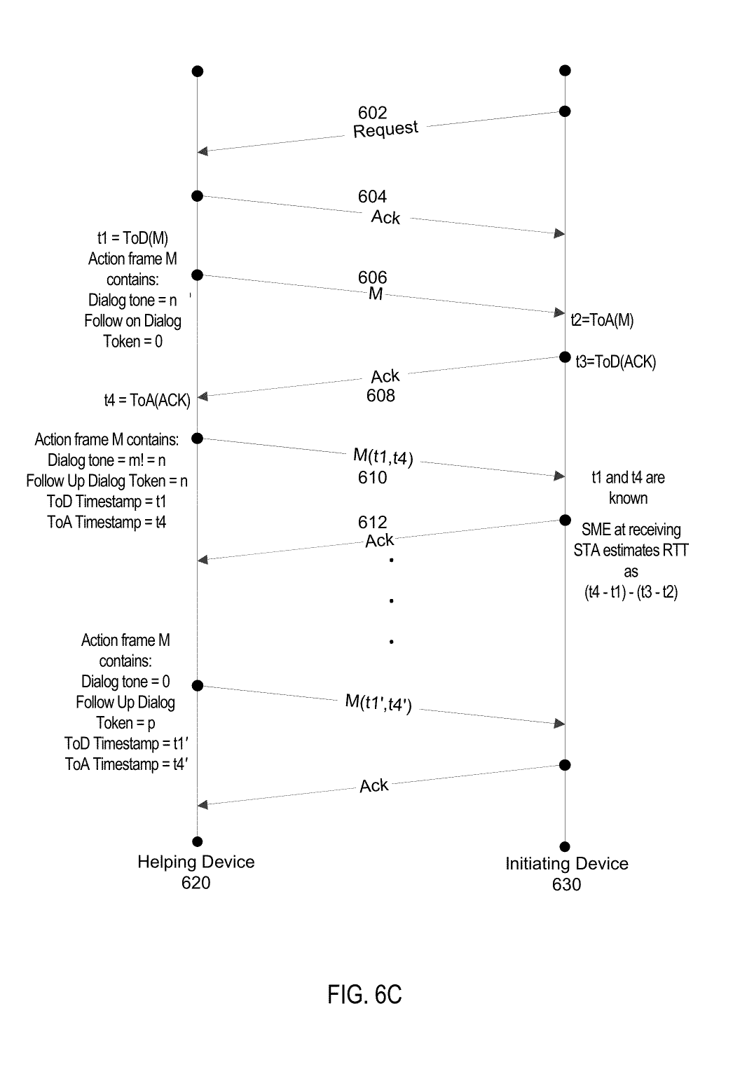

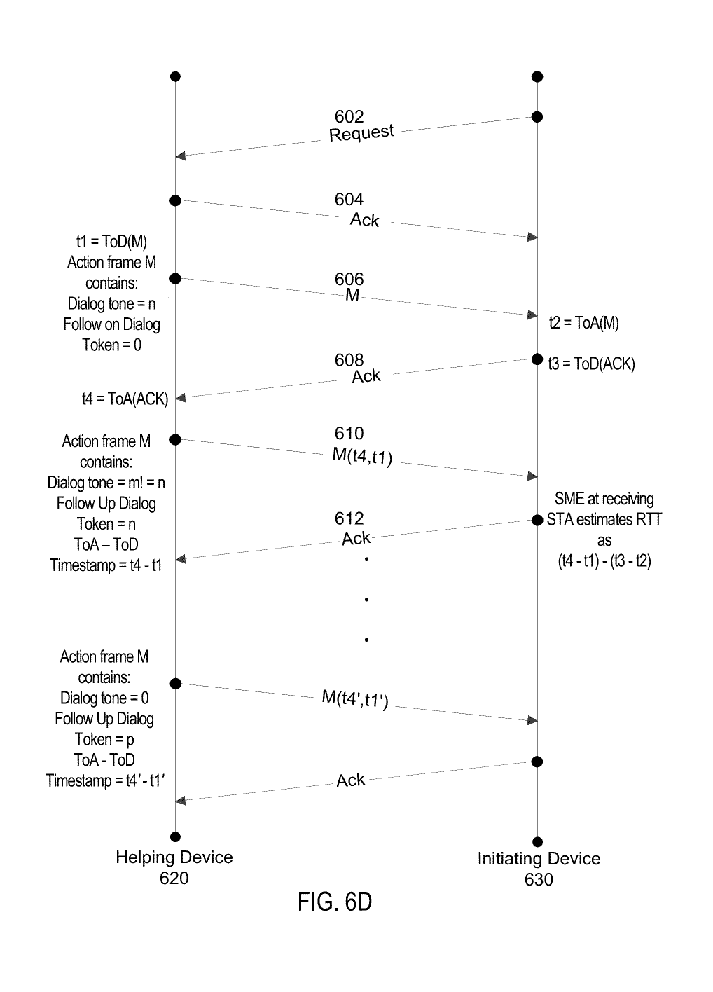

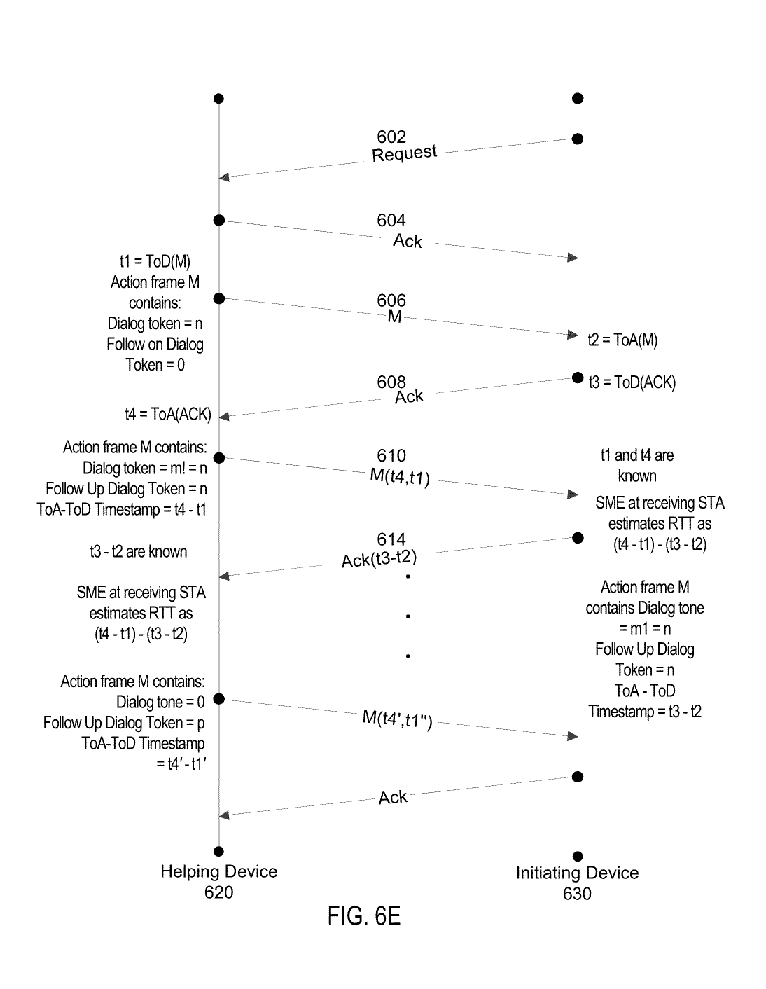

Referring to FIG. 4, embodiments may be consistent with flowchart 400, describing example method steps for determining distance between a first and a second device, according to the disclosures herein. The steps may be performed by a LIE or an AP (e.g., the initiating device as illustrated in FIG. 6A) to determine its location. Alternatively, the steps may be performed in peer to peer communication between two UEs (e.g., an initiating UE and a helping UE) to determine their relative position and/or global position.

At 402, a first device (e.g., the initiating device may transmit a timing measurement request to a second device (e.g., a helping device). For certain embodiments, the second device may not be authenticated or associated with the first device. For example, the first device transmits (e.g., broadcasts) the first signal to a plurality of devices. One or more of the plurality of devices that receive the timing measurement request (e.g., the second device) acknowledge reception of the first signal by transmitting an acknowledgement signal and initiating a timing measurement procedure with the first device.

At 404, the first device receives a first signal from the second device. At 406, the first device transmits a second signal using one of its antennas (e.g., a first antenna) in response to reception of the first signal. The first device may include a plurality of antennas (e.g., including the first antenna). However, the first device may use only one of its antennas and no other antenna in the plurality of antennas to transmit the second signal. For example, the first device may momentarily shut down all of its transmit antennas except the first antenna before transmitting the second signal.

At 408, the first device receives one or more timing measurements corresponding to the first and the second signals from the second device. The one or more timing measurements may include time of departure (TOD) of the first signal from the second device, time of arrival (TOA) of the second signal at the second device, a difference measurement, or the like.

At 410, the first device determines the distance between the first and the second devices based at least on the one or more timing measurements. For example, the first device may determine a round trip time (RTT) that took to exchange the first and the second signals between the first and the second devices. In another embodiment, the first device may determine TOA of the first signal and receive TOD of the first signal from the second device. The first device may subtract the TOD and TOA values to determine the time of flight (TOF) (e.g., the time that took for the first signal to travel to the first device), which may be equal to RTT/2. The first device may then be able to find distance between the two devices based on the speed of light and the determined RTT and/or TOF.

In one embodiment, the first device may transmit one or more timing measurements corresponding to the first and second signals (e.g., TOA of the first signal and/or TOD of the second signal) to the second device. The second device may then be able to determine the distance between the two devices based on the received timing measurements and other timing measurements that are captured by the second device (e.g., TOD of the first TOA of the second signal, and the like).

For some embodiments, a TOD measurement may be a timestamp from one of the antenna ports of the first device that remains active and transmits the second signal while all other antennas are momentarily deactivated and/or are in idle mode. In this case, assuming a environment, the TOD measurement may be unambiguously identified because only one antenna is active while the second signal is transmitted.

In some embodiments, a TOA measurement may be a timestamp from the antenna port with the highest receive gain. For example, assuming that the first device has multiple antennas, the first device can receive the first signal using each of its antennas. The first device may then calculate receive gain of each of its receive antenna ports and select the one with the highest receive gain. Time of arrival of the first signal at the first device may be measured at the selected antenna port with the highest receive gain. In this case, assuming a MIMO environment, the timing measurement with the highest gain may be reasoned to be a real signal received at one of the antenna ports, as opposed to noise, reflections, interference, or other spurious signals.

In some embodiments a TOA measurement may be a timestamp from the receive antenna with the earliest arrival time. For example, the first device may have multiple antennas and receive the first signal using each of the multiple antennas. The first device may then measure timestamps at each of its receive antenna ports and select time of arrival as the earliest arrival time among all the antennas. In this case, assuming a MIMO environment, the timing measurement with the earliest arrival time may be reasoned to be a real signal received with the most direct path from the transmitting device.

In some embodiments a TOA measurement may be a weighted sum of the arrival timestamps at one or more receive antennas of the receiver. For example, the arrival timestamps at different receive antennas may be weighted based on the signal to noise ratio (SNR) of the received signals at each of the receive antennas.

Some embodiments may include TOD measurements that are based on shutting off momentarily (and/or putting in idle mode) all transmit antennas except for one that sends the signals used for position determination. For example, a TOD measurement may be a timestamp from the antenna port that remains active while all other antennas are momentarily deactivated and/or are in idle mode, in this case, assuming a MIMO environment, the TOD measurement may be unambiguously identified because only one antenna is active while the signal associated with the TOD measurement is transmitted. Alternatively, embodiments may interpret a TOD measurement to be a timestamp transmitted from a MIMO device appearing at any of its transmit antenna ports. This definition may account for the fact that the TOD measurement is sent in a MIMO wireless environment containing multiple antennas.

In some embodiments, the first and/or the second signals may be received at the first or the second device with a sampling interval less than 10 ns. For example, signals may be received and sampled with sampling intervals of 0.1 ns, 1 ns, or 1.5 ns, etc. In one embodiment, timing measurements (e.g., TOD, TOA) may be expressed in units of 0.1 nanoseconds. It may be desirable to sample the received signals with sampling intervals less than 10 ns in order to take advantage of the higher bandwidth available in some 802.11 standards, such as 802.11ad and 802.11ac. Higher bandwidth may also be important is performing geo-positioning techniques, due to the processing demand needed to constantly update position information and compute new positions.

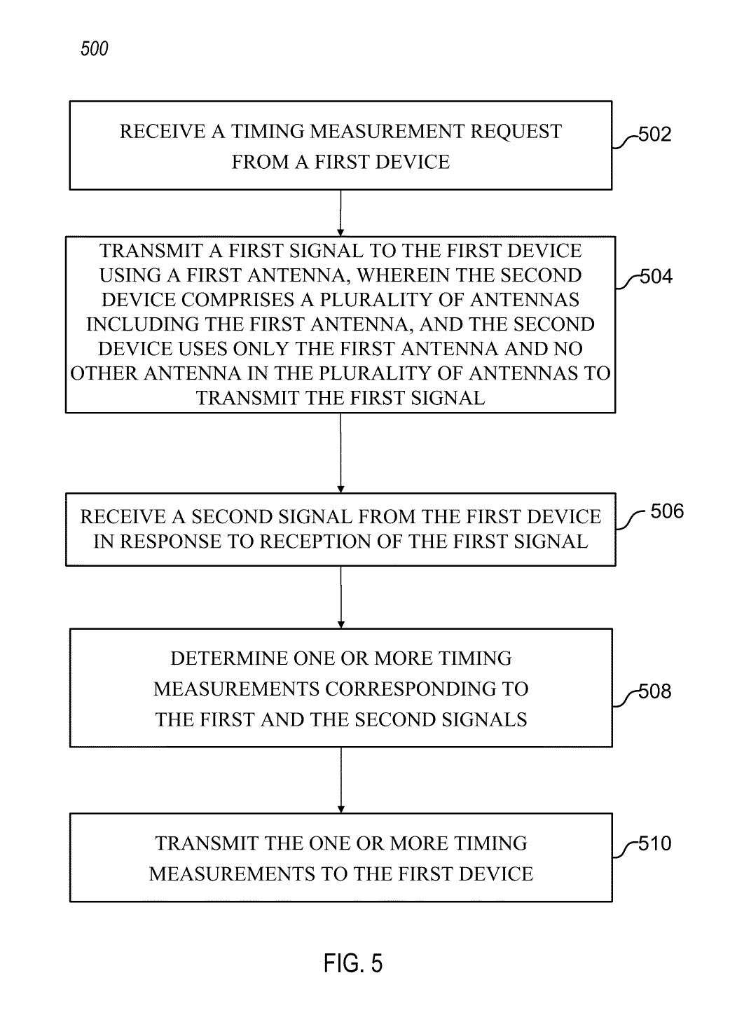

Referring to FIG. 5, embodiments may be consistent with flowchart 500, describing example method steps for determining distance between the first and the second device, according to the disclosures herein. The steps may be performed by a UE or an AP to help determine location of another device. Alternatively, the steps may be performed in peer to peer communication between two UEs to determine their relative position and/or global position.

A first device (e.g., the initiating device) may transmit a timing measurement request to a second device (e.g., the helping device). At 502, the second device transmits a first signal to the first device using one of its antennas (e.g., a first antenna). The second device may include a plurality of antennas (e.g., including the first antenna), and use only the first antenna and no other antenna in the plurality of antennas to transmit the first signal. At 504, the second device receives a second signal from the first device in response to reception of the first signal. At 506, the second device determines one or more timing measurements corresponding to the first and the second signals (e.g., TOA and TOD and/or their difference). At 508, the second device transmits the one or more timing measurements to the first device.

FIGS. 6A through 6E are example charts describing message exchanges between two devices (e.g., an initiating device 630 and a helping device 620) for precise location determination, in accordance with certain embodiments of the present disclosure.

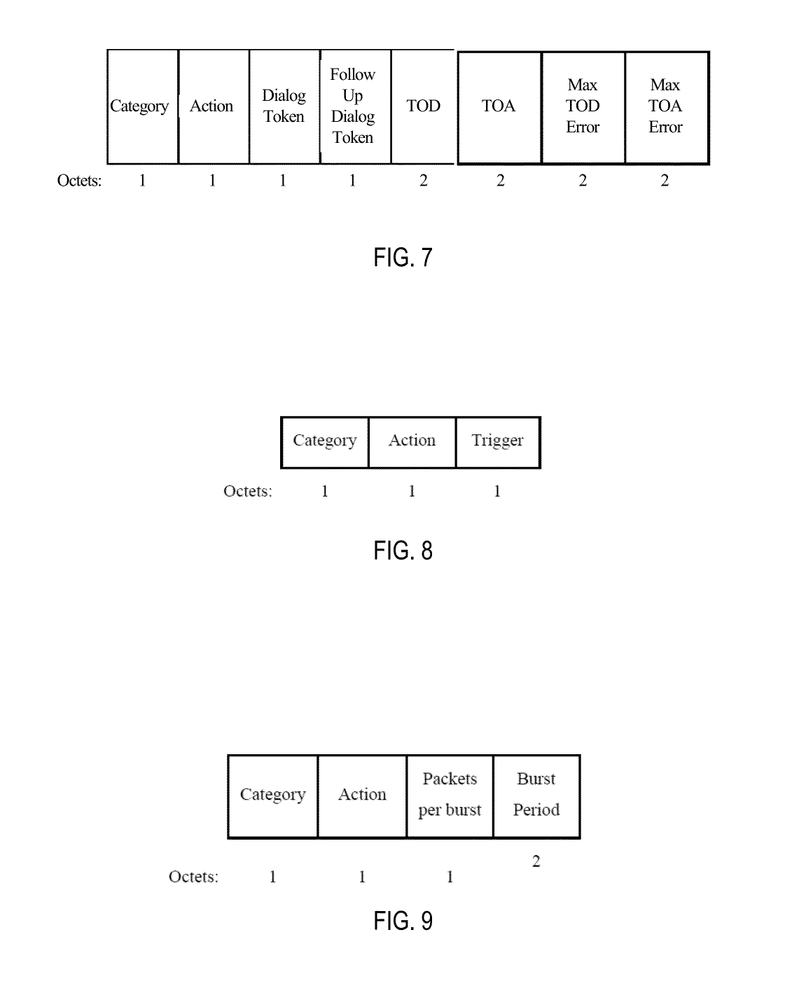

For certain embodiments, a device (e.g., the initiating device 630) may transmit a request message 602 (e.g., a Fine Timing Measurement Request frame) to another device (e.g., the helping device 620), which may be a peer TIE and/or an AP to request it to initiate or to stop an ongoing Fine Timing Measurement procedure. Depending on the value of the Trigger field in the request frame, the helping device initiates or stops the procedure (refer to FIG. 7 for an example format of the fine timing request frame.)

The helping device 520 may transmit Timing Measurement frames in overlapping pairs. The first Timing Measurement frame of a pair (e.g., message M 606) may contain a nonzero Dialog Token. The follow up Timing Measurement frame (e.g., message M 610) may contain a Follow Up Dialog Token set to the value of the Dialog Token in the first frame of the pair (e.g. message M 606). With the first Timing Measurement frame, both devices may capture timestamps. The helping device may capture the time at which the Timing Measurement frame is transmitted (t1). The initiating device may capture the time at which the Timing Measurement frame arrives (t2) and the time at which the acknowledgement (ACK) response is transmitted (t3). The helping device may capture the time at which the ACK arrives (t4). In the follow up Tinting Measurement frame (e.g., M 610), the helping device 620 may transfer the timestamp values it captured (t1 and t4) to the initiating device 630.

In some embodiments, the timing information used for positioning may be embedded in the packets from the initiating device to the helping device, thereby allowing for both the initiating device and helping device to compute RTT measurements. For example, the ACK message 614, as shown in FIG. 413, may have embedded information containing t2 and t3, which may allow the helping device to also have information sufficient to compute RTT. Therefore, the initiating device 630 can either send a normal ACK 612 (as illustrated in FIG. 6A) or send a fine timing measurement ACK 614 as in FIG. 6B, where t2, t3 are embedded in the Fine Timing Measurement ACK 614.

In some embodiments, the fine timing measurement ACK 614 may have the same format as the Timing Measurement frame and may set the Dialog Token value to the Dialog Token of the previously transmitted pair. In this case, the Follow On Dialog Token will not be used and may be set to zero. This mechanism allows for the helping device 620 to also have timing information. It should be noted that the Timing Measurement frame can contain nonzero values in both the Dialog Token and Follow Up Dialog Token fields, meaning that the Action frame contains follow up information from a previous measurement, and new timestamp values are captured to be sent in a future follow up Timing Measurement frame. In one embodiment, the ACK frame (e.g., 608, 612) may have the same channel bandwidth as the action frame M 610.

As illustrated in FIG. 6A, in some embodiments, the initiating device may be able to calculate offset of the local clock relative to that at the helping device, as follows:

Offset=[(t2−t1)−(t4−t3)]/2.

As illustrated in FIGS. 6B and 6C, in some embodiments, the originating and/or the helping devices may calculate the round trip time (RTT) as follows:

RTT=(t4−t1)·(t3−t2).

For certain embodiments, if the ACK for a transmitted Timing Measurement frame is not received, the helping device may retransmit the frame. The helping device may capture a new set of timestamps for the retransmitted frame and its ACK.

For certain embodiments, the above frame exchange may be stopped either by the helping device by sending a Timing Measurement Frame with Dialog Token set to zero, or by the initiating device sending a Fine Timing Measurement ACK frame with Dialog Token set to zero. On receiving a Timing Measurement frame with a Dialog Token for which timestamps have previously been captured, the initiating device may discard previously captured timestamps and capture a new set of timestamps.

In some embodiments, as illustrated in FIGS. 6D and 6E, the initiating device and the helping device may exchange the differences between timestamps, rather than the timestamps themselves. For example, as illustrated in FIGS. 6D and 6E, the helping device may transmit the action frame M 610 including the difference value (e.g., t4−t1) to the initiating device. In one embodiment as illustrated in HG, 6E, the initiating device may also transmit a difference (e.g., t3−t2) as part of the acknowledgement 614 to the helping device. Sending the differences in the timestamps may reduce resources needed for location determination.

FIG. 7 illustrates an example format for a Fine Timing Measurement frame, in accordance with certain embodiments of the present disclosure. As illustrated, the Fine Timing Measurement frame may include a category field, an action field, a dialog token, a Follow Up Dialog Token field, a TOD field, a TOA, a Max TOD Error field and a Max TOA Error field.

The Dialog Token field may be a nonzero value chosen by the helping device to identify the Fine Timing Measurement frame as the first of a pair, with the second or follow-up Fine Timing Measurement frame to be sent later. The Dialog Token field may be set to zero to indicate that the Fine Timing Measurement frame will not be followed by a subsequent follow-up Fine Timing Measurement frame. The Follow Up Dialog Token may be the nonzero value of the Dialog Token field of the previously transmitted Fine Timing Measurement frame to indicate that it is the follow up Fine Timing Measurement frame and that the TOD, TOA, Max TOD Error and Max TOA Error fields contain the values of the timestamps captured with the first Fine Timing Measurement frame of the pair. The Follow Up Dialog Token may be zero to indicate that the Fine Timing Measurement frame is not a follow up to a previously transmitted Fine Timing Measurement frame.

For certain embodiments, the TOD, TOA, Max TOD Error, and Max TOA Error fields may be expressed in units of 0.1 ns. The TOD field may contain a timestamp that represents the time at which the start of the preamble of the previously transmitted Fine Timing Measurement frame appeared at the transmit antenna port.

The Max TOD Error field may contain an upper bound for the error in the value specified in the TOD field. For instance, a value of 2 in the Max TOD Error field may indicate that the value in the TOD field has a maximum error of ±0.02 ns. The Max TOA Error field contains an upper bound for the error in the value specified in the TOA field. For instance, a value of 2 in the Max TOA Error field indicates that the value in the TOA field has a maximum error of ±0.02 ns.

In one embodiment, the Category field in FIG. 7 may be set to the value for Public. In addition, the Public Action field may be set to indicate a “Fine Timing Measurement”. The Trigger field set to the value one may indicate that the initiating device requests a Fine Timing Measurement procedure from the helping device. The trigger field set to the value zero may indicate that the initiating device requests that the helping device stops sending Fine Timing Measurement frames.

Some embodiments may allow for the signals exchanged for the location determination (e.g. Fine Timing Measurement Request and Fine Timing Measurement) to be of class 1 as opposed to class 2 or class 3. As class 1, the device transmitting these signals (e.g., the initiating device) need not be authenticated or associated with the device that receives these signals (e.g., the helping device).

FIG. 8 illustrates an example format for a Fine Timing Measurement Request frame, in accordance with certain embodiments of the present disclosure. As illustrated, the Fine Timing Measurement Request frame may include a Category field, an Action field and a Trigger field, each of which may be one octet. In one embodiment, the Category field may be set to the value for Public. In addition, the Public Action field may be set to indicate a “Fine Timing Measurement Request” frame. The Trigger field set to the value 1 may indicate that the initiating device requests a Fine Timing Measurement procedure from the helping device. The trigger field set to the value zero may indicate that the initiating device requests that the helping device stops sending Fine Timing Measurement frames.

In one embodiment, a Fine Timing Measurement Negotiation frame may be transmitted by the initiating device to initiate a fine timing procedure with the helping device. FIG. 9 illustrates an example format for the Fine Timing Measurement Negotiation frame, in accordance with certain aspects of the present disclosure. For some embodiments, the Category field may be set to the value for “Public” and the Public Action field is set to indicate a “Fine Timing Measurement Negotiation” frame. In this example, the Packets per Burst field may indicate how many packets the initiating device would like to receive for measurement purposes. The Burst Period may indicate how often, in units of 100 milliseconds, the message exchange happens. A value of zero in the Burst Period may mean that only a single burst is desired.

Consistent with the descriptions in FIGS. 1 through 9, some embodiments may send timing measurements using an example message format as follows. As described above, a timing measurement frame may comprise three octets: a Category byte, an Action byte, and a Trigger byte. An example category may be wireless network management (WNM), which corresponds to category 10; an example action field value may be Timing Measurement Request, which corresponds to value 25 and an example trigger value of 1 may be used to signal the initiation of the timing measurement request. Thus, the three octets may be formatted as follows: Category=00001010 (i.e., 10), Action=00011001 (i.e., 25), and Trigger=00000001 (i.e., 1). Thus, in some embodiments, an example packet to initiate a timing measurement request may be: 000010100001100100000001. Accordingly, persons of ordinary skill in the art my readily understand how other packets may be structured to practice embodiments of the present invention.

As described earlier, the initiating device may transmit timing measurement requests to a plurality of devices in its vicinity. Using the procedures described herein, the initiating, device may determine three or more distance measurements corresponding to three or more of the plurality of neighboring devices. The device may then determine its position based on the distance measurements and global positioning information of each device corresponding to each of the distance measurements.

Many embodiments may be made in accordance with specific requirements. For example, customized hardware might also be used, and/or particular elements might be implemented in hardware, software (including portable software, such as applets, etc.), or both. Further, connection to other computing devices such as network input/output devices may be employed.

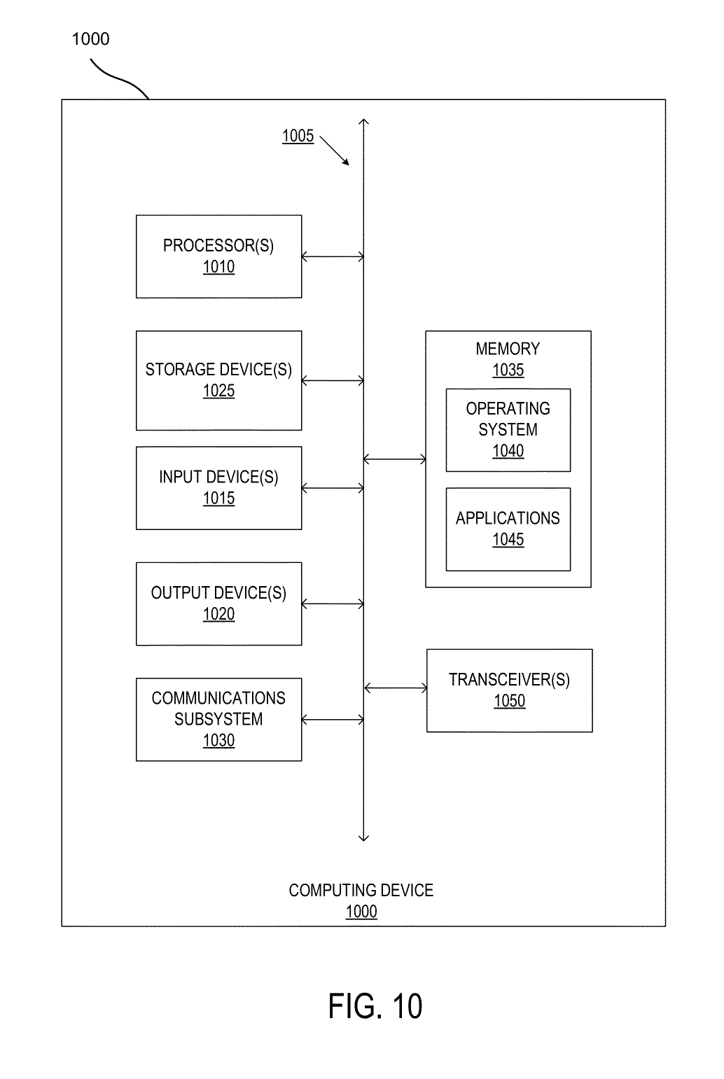

Having described multiple aspects of improving location determinations in wireless devices using multiple antennas, an example of a computing system in which various aspects of the disclosure may be implemented will now be described with respect to FIG. 10. According to one or more aspects, a computer system as illustrated in FIG. 10 may be incorporated as part of a computing device, which may implement, perform, and/or execute any and/or all of the features, methods, and/or method steps described herein. For example, computer system 1000 may represent some of the components of a hand-held device. A hand-held device may be any computing device with an input sensory unit, such as a wireless receiver or modem. Examples of a hand-held device include but are not limited to video game consoles, tablets, smart phones, televisions, and mobile devices or mobile stations. In some embodiments, the system 1000 is configured to implement any of the methods described above. FIG. 10 provides a schematic illustration of one embodiment of a computer system 1000 that can perform the methods provided by various other embodiments, as described herein, and/or can function as the host computer system, a remote kiosk/terminal, a point-of-sale device, a mobile device, a set-top box, and/or a computer system. FIG. 10 is meant only to provide a generalized illustration of various components, any and/or all of which may be utilized as appropriate. FIG. 10, therefore, broadly illustrates how individual system elements may be implemented in a relatively separated or relatively more integrated manner.

The computer system 1000 is shown comprising hardware elements that can be electrically coupled via a bus 1005 (or may otherwise be in communication, as appropriate). The hardware elements may include one or more processors 1010, including without limitation one or more general-purpose processors and/or one or more special-purpose processors (such as digital signal processing chips, graphics acceleration processors, and/or the like); one or more input devices 1015, which can include without limitation a camera, wireless receivers, wireless sensors, a mouse, a keyboard and/or the like; and one or more output devices 1020, which can include without limitation a display unit, a printer and/or the like. In some embodiments, the one or more processor 1010 may be configured to perform a subset or all of the functions described above with respect to FIG. 4. The processor 1010 may comprise a general processor and/or and application processor, for example. In some embodiments, the processor is integrated into an element that processes visual tracking device inputs and wireless sensor inputs.

The computer system 1000 may further include (and/or be in communication with) one or more non-transitory storage devices 1025, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 1000 might also include a communications subsystem 1030, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 1030 may permit data to be exchanged with a network (such as the network described below, to name one example), other computer systems, and/or any other devices described herein. In many embodiments, the computer system 1000 will further comprise a non-transitory working memory 1035, which can include a RAM or ROM device, as described above. In some embodiments communications subsystem 1030 may interface with transceiver(s) 1050 configured to transmit and receive signals from APs or mobile devices. Some embodiments may include a separate receiver or receivers, and a separate transmitter or transmitters.

The computer system 1000 also can comprise software elements, shown as being currently located within the working memory 1035, including an operating system 1040, device drivers, executable libraries, and/or other code, such as one or more application programs 1045, which may comprise computer programs provided by various embodiments, and/or may be designed to implement methods, and/or configure systems, provided by other embodiments, as described herein. Merely by way of example, one or more procedures described with respect to the method(s) discussed above, for example as described with respect to FIG. 4, might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 1025 described above. In some cases, the storage medium might be incorporated within a computer system, such as computer system 1000. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 1000 and/or might take the form of source and/or installable code, which, upon compilation and/or installation on the computer system 1000 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computer system 1000) to perform methods in accordance with the disclosure. For example, some or all of the procedures of the described methods may be performed by the computer system 1000 in response to processor 1010 executing one or more sequences of one or more instructions (which might be incorporated into the operating system 1040 and/or other code, such as an application program 1045) contained in the working memory 1035. Such instructions may be read into the working memory 1035 from another computer-readable medium, such as one or more of the storage device(s) 1025. Merely by way of example, execution of the sequences of instructions contained in the working memory 1035 might cause the processor(s) 1010 to perform one or more procedures of the methods described herein, for example methods described with respect to FIG. 10.

The terms “machine-readable medium” and “computer-readable medium,” as used herein, refer to any medium that participates in providing data that causes a machine to operate in a specific fashion. In an embodiment implemented using the computer system 1000, various computer-readable media might be involved in providing instructions/code to processor(s) 1010 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 1025. Volatile media include, without limitation, dynamic memory, such as the working memory 1035. Transmission media include, without limitation, coaxial cables, copper wire and fiber optics, including the wires that comprise the bus 1005, as well as the various components of the communications subsystem 1030 (and/or the media by which the communications subsystem 1030 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 1010 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1000. These signals, which might be in the form of electromagnetic signals, acoustic signals, optical signals and/or the like, are all examples of carrier waves on which instructions can be encoded, in accordance with various embodiments of the invention.

The communications subsystem 1030 (and/or components thereof) generally will receive the signals, and the bus 1005 then might carry the signals (and/or the data, instructions, etc. carried by the signals) to the working memory 1035, from which the processor(s) 1010 retrieves and executes the instructions. The instructions received by the working memory 1035 may optionally be stored on a non-transitory storage device 1025 either before or after execution by the processor(s) 1010. Memory 1035 may contain at least one database according to any of the databases and methods described herein. Memory 1035 may thus store any of the values discussed in any of the present disclosures, including FIG. 4 and related descriptions.

The methods described in FIGS. 4 and 5 may be implemented by various blocks in FIG. 10. For example, processor 1010 may be configured to perform any of the functions of blocks in diagram 400. Storage device 1025 may be configured to store an intermediate result, such as a globally unique attribute or locally unique attribute discussed within any of blocks mentioned herein. Storage device 1025 may also contain a database consistent with any of the present disclosures. The memory 1035 may similarly be configured to record signals, representation of signals, or database values necessary to perform any of the functions described in any of the blocks mentioned herein. Results that may need to be stored in a temporary or volatile memory, such as RAM, may also be included in memory 1035, and may include any intermediate result similar to what may be stored in storage device 1025. Input device 1015 may be configured to receive wireless signals from satellites and/or base stations according to the present disclosures described herein. Output device 1020 may be configured to display images, print text, transmit signals and/or output other data according to any of the present disclosures.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does nut limit the scope of the disclosure.

Various examples have been described. These and other examples are within the scope of the following claims.

What is claimed is:

1. A method for determining a distance between a first device and a second device, comprising:
at the first device, receiving a first signal from the second device;
in response to receiving the first signal, transmitting a second signal from the first device using a first antenna, wherein the first device comprises a plurality of antennas including the first antenna, and the first device uses only the first antenna and no other antenna in the plurality of antennas to transmit the second signal;
receiving one or more first timing measurements corresponding to the first and the second signals from the second device; and
determining the distance between the first device and the second device based at least on the one or more first timing measurements.

2. The method of claim 1, further comprising:
transmitting a timing measurement request to the second device, wherein the first signal is received in response to the timing measurement request.

3. The method of claim 1, further comprising:
determining one or more second timing measurements, comprising time of arrival of the first signal at the first device and time of departure of the second signal from the first device.

4. The method of claim 3, further comprising:
determining round trip time (RTT) based on the one or more first timing measurements and the one or more second timing measurements, wherein the distance is determined based at least on the round trip time.

5. The method of claim 4, wherein the RTT is determined based at least on the following equation:
RTT=(t4−t1)−(t3−t2), wherein t1 represents time of departure of the first signal from the second device, t2 represents the time of arrival of the first signal at the first device, t3 represents the time of departure of the second signal from the first device and t4 represents time of arrival of the second signal at the second device.

6. The method of claim 3, further comprising:
determining time of flight (TOF) of the first signal based at least on time of departure of the first signal from the second device and the time of arrival of the first signal at the first device.

7. The method of claim 3, wherein the time of arrival of the first signal comprises the earliest time that the first signal is received by one or more antennas of the first device.

8. The method of claim 3, wherein the time of arrival of the first signal comprises arrival time of the first signal at one of the receive antennas of the first device with highest received signal strength among all of the receive antennas of the first device.

9. The method of claim 3, wherein the time of arrival of the first signal comprises a weighted sum of one or more arrival times of the first signal at one or more receive antennas of the first device.

10. The method of claim 1, wherein receiving the first signal comprises receiving the first signal with a sampling rate less than 10 nanoseconds (ns).

11. The method of claim 1, wherein receiving the first signal comprises receiving the first signal with a sampling rate equal to 0.1 nanosecond (ns).

12. The method of claim 1, wherein the wireless communications comply with one of the Institute of Electrical and Electronics Engineers (IEEE) 802.11v, 802.11ad, 802.11mc or 802.11ac standards.

13. The method of claim 1, wherein the one or more first timing measurements comprise a difference measurement between a first time stamp indicative of time of arrival of the first signal at the first device and a second time stamp indicative of time of departure of the second signal from the first device.

14. The method of claim 13, wherein determining the distance between the first device and the second device comprises:
determining round trip time (WIT) based at least on the difference measurement; and
determining the distance between the first device and the second device based at least on the determined RTT.

15. The method of claim 14, wherein the difference measurement and the RTT are determined based on the following equations:
A=t4−t1, and RTT=Δ−(t3−t2), wherein t1 represents time of departure of the first signal from the second device, t2 represents the time of arrival of the first signal at the first device, t3 represents the time of departure of the second signal from the first device, and t4 represents time of arrival of the second signal at the second device, and Δ represents the difference measurement.

16. The method of claim 1, further comprising:
transmitting a timing measurement request to a plurality of second devices; and
determining at least three distance measurements between the first device and at least three of the plurality of second devices.

17. The method of claim 16, further comprising:
determining location of the first device based at least on the at least three distance measurements and global positioning information of devices that correspond to each of the at least three distance measurements.

18. The method of claim 1, further comprising:
transmitting one or more second timing measurements to the second device, wherein the one or more second timing measurements correspond to the first and the second signals.

19. A method for determining a distance between a first device and a second device, comprising:
by the second device, transmitting a first signal to the first device using a first antenna, wherein the second device comprises a plurality of antennas including the first antenna, and the second device uses only the first antenna and no other antenna in the plurality of antennas to transmit the first signal;
receiving a second signal from the first device in response to reception of the first signal;
determining one or more first timing measurements corresponding to the first and the second signals; and
transmitting the one or more first timing measurements to the first device.

20. The method of claim 19, further comprising:
receiving a timing measurement request, wherein the first signal is transmitted in response to the timing measurement request.

21. The method of claim 19, wherein determining the one or more first timing measurements comprises:
capturing time of departure of the first signal from the second device and time of arrival of the second signal at the second device.

22. The method of claim 21, wherein the time of arrival of the second signal comprises the earliest time that the second signal is received by one or more antennas of the second device.

23. The method of claim 21, wherein the time of arrival of the second signal comprises arrival time of the second signal at one of the receive antennas of the second device with highest received signal strength among all of the receive antennas of the second device.

24. The method of claim 21, wherein the time of arrival of the second signal comprises a weighted sum of one or more arrival times of the second signal at one or more receive antennas of the second device.

25. The method of claim 19, further comprising:
receiving one or more second timing measurements from the first device;
determining round trip time (RTT) based at least on the one or more first timing measurements and the one or more second timing measurements; and
determining the distance between the first device and the second device based at least on the RTT.

26. The method of claim 25, wherein the RTT is determined based at least on the following equation:
RTT=(t4−t1)−(t3−t2), wherein t1 represents the time of departure of the first signal from the second device, t2 represents time of arrival of the first signal at the first device, t3 represents time of departure of the second signal from the first device and, t4 represents the time of arrival of the second signal at the second device.

27. The method of claim 19, wherein receiving the second signal comprises receiving the second signal with a sampling rate less than 10 nanoseconds (ns).

28. The method of claim 19, wherein receiving the second signal comprises receiving the second signal with a sampling rate equal to 0.1 nanosecond.

29. The method of claim 19, wherein the wireless communications comply with one of the Institute of Electrical and Electronics Engineers (IEEE) 802.11v, 802.11ad, 802.11mc or 802.11ac standards.

30. The method of claim 19, further comprising:
receiving one or more second timing measurements from the first device; and
determining the distance between the first device and the second device based at least on the received one or more second timing measurements.

31. The method of claim 30, wherein the one or more second timing measurements comprise a difference measurement between a first time stamp indicative of time of arrival of the first signal at the second device and a second time stamp indicative of time of departure of the second signal from the second device.

32. The method of claim 31, further comprising:
determining round trip time (RTT) based at least on the difference measurement, wherein the distance between the first device and the second device is determined based at least on the determined RTT.

33. An apparatus for determining a distance from a device, comprising:
a plurality of antennas;
a receiver configured to receive a first signal from the device using at least one of the plurality of antennas;
a transmitter configured to transmit, in response to receiving the first signal, a second signal using a first antenna of the plurality of antennas, wherein the apparatus uses only the first antenna and no other antenna in the plurality of antennas to transmit the second signal;
wherein the receiver is further configured to receive one or more first timing measurements corresponding to the first and the second signals;
a processor configured to determine the distance from the device based at least on the one or more first timing measurements;
and a memory coupled to the processor.

34. The apparatus of claim 33, wherein the transmitter is further configured to transmit a timing measurement request to the device, wherein the first signal is received in response to the timing measurement request.

35. The apparatus of claim 33, wherein the processor is further configured to determine one or more second timing measurements, comprising time of arrival of the first signal at the apparatus and time of departure of the second signal from the apparatus.

36. The apparatus of claim wherein the processor is further configured to:
determine round trip time (RTT) based on the one or more first timing measurements and the one or more second timing measurements, and
determine the distance based at least on the round trip time.

37. The apparatus of claim 36, wherein the processor is further cot figured to determine RTT based at least on the following equation:
RTT=(t4−t1)−(t3−t2), wherein t1 represents time of departure of the first signal from the second device, t2 represents the time of arrival of the first signal at the apparatus, t3 represents the time of departure of the second signal from the apparatus and t4 represents time of arrival of the second signal at the device.

38. The apparatus of claim 35, wherein the processor is further configured to determine time of flight (TOF) of the first signal based at least on time of departure of the first signal from the second device and the time of arrival of the first signal at the apparatus.

39. The apparatus of claim 35, wherein the time of arrival of the first signal comprises the earliest time that the first signal is received by one or more antennas of the apparatus.

40. The apparatus of claim 35, wherein the time of arrival of the first signal comprises arrival time of the first signal at one of the receive antennas of the apparatus with highest received signal strength among all of the receive antennas of the apparatus.

41. The apparatus of claim 35, wherein the time of arrival of the first signal comprises a weighted sum of one or more arrival times of the first signal at one or more receive antennas of the apparatus.

42. The apparatus of claim 33, wherein the receiver is further configured to receive the first signal with a sampling rate less than 10 nanoseconds (ns).

43. The apparatus of claim 33, wherein the receiver is further configured to receive the first signal with a sampling rate equal to 0.1 nanosecond (ns).

44. The apparatus of claim 33, wherein the processor is further configured to comply with one of the Institute of Electrical and Electronics Engineers (IEEE) 802.11v, 802.11ad, 802.11mc or 802.11ac standards.

45. The apparatus of claim 33, wherein the one or more first timing measurements comprise a difference measurement between a first time stamp indicative of time of arrival of the first signal at the apparatus and a second time stamp indicative of time of departure of the second signal from the apparatus.

46. The apparatus of claim 45, the processor is further configured to:
determine round trip time (RTT) based at least on the difference measurement; and
determine the distance from the device based at least on the determined RTT.

47. The apparatus of claim 46, wherein the processor is further configured to determine the difference measurement and the RTT based on the following equations:
Δ=t4−t1, and RTT=Δ−(t3−t2), wherein t1 represents time of departure of the first signal from the device, t2 represents the time of arrival of the first signal at the apparatus, t3 represents the time of departure of the second signal from the apparatus, and t4 represents time of arrival of the second signal at the device, and Δ represents the difference measurement.

48. The apparatus of claim 33, wherein the transmitter is further configured to transmit a timing measurement request to a plurality of devices, and the processor is further configured to determine at least three distance measurements between the apparatus and at least three of the plurality of devices.

49. The apparatus of claim 48, wherein the processor is further configured to determine location of the apparatus based at least on the at least three distance measurements and global positioning information of devices that correspond to each of the at least three distance measurements.

50. The apparatus of claim 33, wherein the transmitter is further configured to transmit one or more second timing measurements to the device, wherein the one or more second timing measurements correspond to the first and the second signals.

51. An apparatus for determining a distance from a device, comprising:
a plurality of antennas;
a transmitter configured to transmit a first signal to the device using a first antenna of the plurality of antennas, wherein the apparatus uses only the first antenna and no other antenna in the plurality of antennas to transmit the first signal;
a receiver configured to receive a second signal from the first device in response to reception of the first signal;
a processor configured to determine one or more first timing measurements corresponding to the first and the second signals; and
wherein the transmitter is further configured to transmit the one or more first timing measurements to the device.

52. The apparatus of claim 51, wherein the receiver is further configured to receive a timing measurement request, wherein the transmitter is further configured to transmit the first signal in response to the timing measurement request.

53. The apparatus of claim 51, wherein the processor is further configured to capture time of departure of the first signal from the apparatus and time of arrival of the second signal at the apparatus.

54. The apparatus of claim 53, wherein the time of arrival of the second signal comprises the earliest time that the second signal is received by one or more antennas of the apparatus.

55. The apparatus of claim 53, wherein the time of arrival of the second signal comprises arrival time of the second signal at one of the receive antennas of the apparatus with highest received signal strength among all of the receive antennas of the apparatus.

56. The apparatus of claim 53, wherein the time of arrival of the second signal comprises a weighted sum of one or more arrival times of the second signal at one or more receive antennas of the apparatus.

57. The apparatus of claim 51, wherein the receiver is further configured to receive one or more second timing measurements from the device;
and the processor is further configured to determine round trip time (RTT) based at least on the one or more first timing measurements and the one or more second timing measurements, and determine the distance from the device based at least on the RTT.

58. The apparatus of claim 57, wherein the processor is further configured to determine RTT based at least on the following equation:
RTT=(t4−t1)−(t3−t2), wherein t1 represents the time of departure of the first signal from the apparatus, t2 represents time of arrival of the first signal at the device, t3 represents time of departure of the second signal from the device and, t4 represents the time of arrival of the second signal at the apparatus.

59. The apparatus of claim 51, wherein the receiver is further configured to receive the second signal with a sampling rate less than 10 nanoseconds (ns).

60. The apparatus of claim 51, wherein the receiver is further configured to receive the second signal with a sampling rate equal to 0.1 nanosecond.

61. The apparatus of claim 51, wherein the wireless communications comply with one of the institute of Electrical and Electronics Engineers (IEEE) 802.11v, 802.11ad, 802.11mc or 802.11ac standards.

62. The apparatus of claim 51, wherein the receiver is further configured to receive one or more second timing measurements from the device; and
the processor is further configured to determine the distance from the device based at least on the received one or more second timing measurements.

63. The apparatus of claim 62, wherein the one or more second timing measurements comprise a difference measurement between a first time stamp indicative of time of arrival of the first signal at the apparatus and a second time stamp indicative of time of departure of the second signal from the apparatus.

64. The apparatus of claim 63, wherein the processor is further configured to determine round trip time (RTT) based at least on the difference measurement, wherein the distance from the device is determined based at least on the determined RTT.

65. An apparatus for determining a distance from a device, comprising:
means for receiving a first signal from the device;
means for transmitting a second signal from the first device, in response to receiving the first signal and using a first antenna, wherein the apparatus comprises a plurality of antennas including the first antenna, and the first device uses only the first antenna and no other antenna in the plurality of antennas to transmit the second signal;
means for receiving one or more first timing measurements corresponding to the first and the second signals from the device; and
means for determining the distance from the device based at least on the one or more first timing measurements.

66. An apparatus for determining distance from a device, comprising:
means for transmitting a first signal to the device using a first antenna, wherein the apparatus comprises a plurality of antennas including the first antenna, and the apparatus uses only the first antenna and no other antenna in the plurality of antennas to transmit the first signal;
means for receiving a second signal from the device in response to reception of the first signal; and
means for determining one or more first timing measurements corresponding to the first and the second signals, wherein the means for transmitting is further configured to transmit the one or more first timing measurements to the device.

67. A non-transitory processor-readable medium for determining distance between a first device and a second device comprising processor-readable instructions configured to cause a processor to:
at the first device, receive a first signal from the second device;
in response to receiving the first signal, transmit a second signal from the first device using a first antenna, wherein the first device comprises a plurality of antennas including the first antenna, and the first device uses only the first antenna and no other antenna in the plurality of antennas to transmit the second signal;
receive one or more first timing measurements corresponding to the first and the second signals from the second device; and
determine the distance between the first device and the second device based at least on the one or more first timing measurements.

68. A non-transitory processor-readable medium for determining distance between a first device and a second device, comprising processor-readable instructions configured to cause a processor to:
transmit a first signal to the first device using a first antenna of the second device, wherein the second device comprises a plurality of antennas including the first antenna, and the second device uses only the first antenna and no other antenna in the plurality of antennas to transmit the first signal;
receive a second signal from the first device in response to reception of the first signal;
determine one or more first timing measurements corresponding to the first and the second signals; and
transmit the one or more first timing measurements to the first device.
